(19) United States
(12) Patent Application Publication
(10) Pub. No.: US 2007/0257805 A1
(43) Pub. Date: Nov. 8, 2007

(54) Device for the Signalling and Lighting During an Emergency Condition

(76) Inventor: Stefano Gaglianone, Roma (IT)

Correspondence Address: NIXON & VANDERHYE, PC, 901 NORTH GLEBE ROAD, 11TH FLOOR, ARLINGTON, VA, 22203, US

(21) Appl. No.: 11/662,797

(22) PCT Filed: Sep. 15, 2004
(86) PCT No.: PCT/IT04/00500

§ 371 Date: Apr. 11, 2007

(51) Int. Cl. G08B 17/00; G08B 21/00

(52) U.S. Cl. 340/584; 340/540

(57) ABSTRACT

A device for the signalling and lighting during an emergency condition, comprising a casing wherein a visible light source is housed, characterized in that it further comprises a second visible UV light source. The device is particularly advantageous in applications for an emergency condition with very poor visibility.

The present invention refers to a device for the signalling and lighting during an emergency condition, and, more precisely, to a device for the signalling and lighting during an emergency condition such as a fire, poor visibility or the like in closed or open environments, in order to satisfy the applicative demands of the various European legislations in the field of emergency lighting.

In the art, there are already known different emergency lighting devices for any use, both in open and closed zones. According to the legislations drawn up by the supervising bodies, there is the obligation to install such devices for the signalling and lighting in any activity or business, and according to sizes, dimension, or hazardousness of the environment in which the abovementioned devices are to be positioned.

To date, the state of the art provides emergency lighting devices having a visible white-colored light, whatever the application field thereof or the size of the environment be in which they are applied. White lamps prove effective when operating in a situation of lack of indoor lighting. However, they entail a drawback in that their effectiveness wanes when operating in presence of smoke especially in closed environment.

In fact, white-light radiance in environments with smoke tends to light the latter, generating dangerous and inhibitory refraction or glare phenomena, thereby limiting visibility as well as orientation where there should be ensured a lighting fostering the use and the sighting of escape routes, evacuation routes, signs and/or the environmental signage preset for this purpose.

Moreover, the same drawback of the refraction of light onto smoke or fog particles, mentioned above for closed environments, also occurs in open environments with smoke, or anyhow exhibiting poor visibility due to atmospheric agents like fog, etc.

Therefore, a main object of the present invention is to solve the abovementioned drawbacks on emergency lighting of the state of the art, by providing a device for the signalling and lighting on an emergency condition ensuring an excellent visibility of the sign to be lighted, even under poor visibility conditions.

Hence, the present invention provides a device for the signalling and lighting on an emergency condition according to claim 1.

Hereinafter, there will be provided a detailed description of a preferred embodiment of the device for the signalling and lighting during an emergency condition according to the present invention, given by way of example and without limitative purposes, making reference to the annexed drawings, wherein:

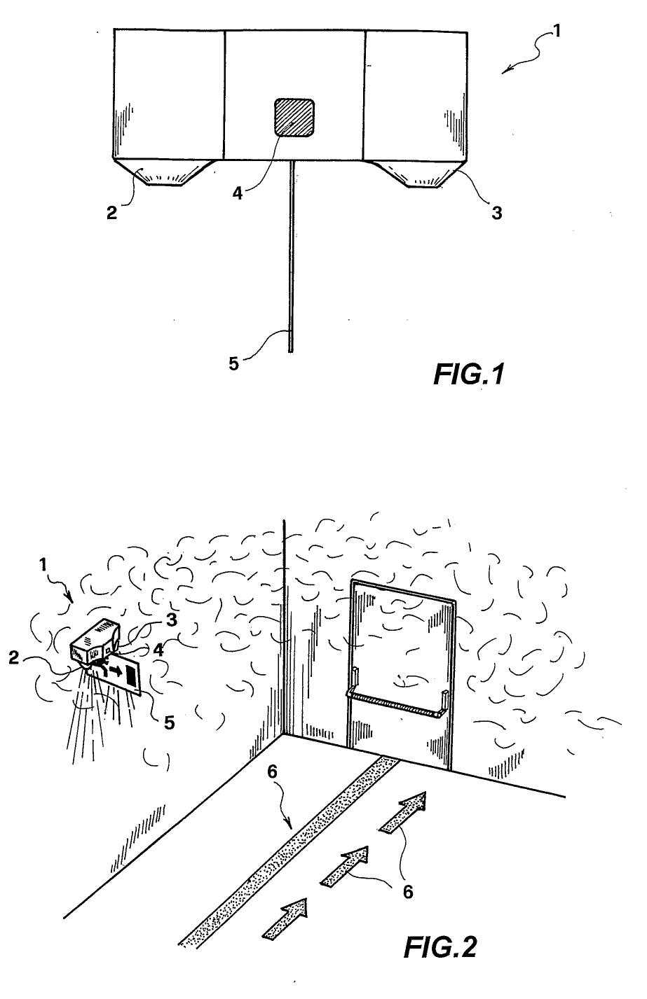

FIG. 1 is a schematic view of the lighting device of the present invention; and

FIG. 2 is a schematic view of the lighting device of the present invention in an operative condition thereof.

Referring now to the figures, the device provides a fixture 1 in which two light sources 2 and 3, respectively, are housed.

The light sources 2 and 3 are housed in a manner such as to generate a beam of light in a desired direction, and according to the use thereof. More precisely, according to the invention the first light source 2 is a white-light source housed in the fixture 1 with the aim of enabling a safe evacuation from a place in case of a common power shortage (i.e. under conditions of lack of indoor lighting and/or absence of smoke), and as mentioned by the European legislation.

On the other hand, the second light source 3 is a (Wood's) violet-color UV light source with the aim of providing light in the presence of smoke without lighting the latter, thereby fostering the sighting of the signage preset near the fixture.

According to a first aspect of the present invention, it is provided that the device 1 for the signalling and lighting during an emergency condition is energized by means of a common external supply mains (to which it is usually connected) as well as autonomously in case of cutoff from the latter.

According to a second aspect of the present invention, it is advantageously provided that the device 1 for the signalling and lighting during an emergency condition provides also a smoke detector 4, housed in the fixture 1 or externally thereto. According to this arrangement, the operation of the device for the signalling and lighting during an emergency condition is managed and assisted by the smoke detector 4.

More precisely, the smoke detector 4 inserted in said fixture 1, has the task of controlling and managing an emergency condition in case of smoke, and of providing information to a control unit and to the electric circuits thereof (better described hereinafter).

Moreover, according to the invention, the fixture 1 may also be provided with one or more informative signboards or signs 5 apt to be lighted during the operation of the device and therefore to provide the required information to the users. More specifically, the signs 5 may also be finished with photo-reactive varnishes of the same color provided by the legislations in force, in order to make the former suitable both for the emergency lighting system (white light) and for the anti-panic (open area) lighting system (Wood's UV light).

Referring now to FIG. 2, according to the present invention it is provided a signage 6 finished with photo-reactive varnishes, in a manner such as to reflect the light of the UV light source 3 even under conditions of poor visibility owing to the presence of smoke, etc. Thus, the chances of onset of panic are reduced, and occupants are enabled to safely reach the evacuation routes, by providing visibility conditions suitable for the sighting of the latter and/or of the escape routes even in the presence of smoke.

Hereinafter, there will be provided a detailed description of the managing system of the device for the signalling and lighting during an emergency condition according to the present invention.

The device is designed to provide two functionally distinct lighting systems. A first electric circuit is dedicated to the (white light) source 2 in charge of the emergency lighting in the event of a shortage of the common external power supply. Of course, also the use of a permanently operating source 2 cannot be ruled out.

On the other hand, a second circuit is dedicated to the source 3, preset as ‘anti-panic lighting’ and having the purpose of reducing the chances of onset of panic. The source 3 can be activated by the smoke detector 4 that, alarmed by the presence of smoke, sends a signal to the main control unit, blocking the circuit which energizes the first white-light source 2 and switching the power up to the (Wood's) UV light source 3. Then, the latter will remain powered up until abatement of the smoke levels within range of the device for the signalling and lighting during an emergency condition, thereby ensuring an appropriate lighting anywhere and aiding the rescuers' work.

This arrangement gives to the device for the signalling and lighting during an emergency condition of the present invention the possibility of operating intelligently and independently from the other signalling devices usually present on the various premises, by providing suitable lighting on each individual premise according to the environmental situation in which it has to operate.

According to another aspect of the device for the signalling and lighting during an emergency condition of the present invention, the same may be connected to a network of fixtures via control units and/or main boards and/or software programs. This arrangement has the advantage of giving a well-defined summary of the emergency condition to be faced by rescuers, the exact location, detected by one or more fixtures 1 of the network, of any fire, as well as the veering direction of the smoke generated by the latter.

According to an alternative embodiment of the lighting device of the present invention, the same may be managed by any kind of detector, i.e. heat, gas, Carbon oxide, CFCs, etc detectors.

According to a further alternative embodiment of the device of the present invention, in the most severe applications and for high-risk areas or in particularly dangerous places the detector 4, besides from activating the lamp better suited to the actual emergency condition and sending information to the central control unit, could activate a webcam or a micro camera inserted in the fixture 1, in order to provide online images of the emergency condition under way and facilitate data acquisition, providing to the rescuers with an accurate summary of the extent of the emergency to be faced, and plan an “ad hoc” intervention strategy for the emergency condition at issue.

Furthermore, according to another alternative embodiment of the device of the present invention, for the most severe applications also a laser light may be installed in the fixture, in addition to the two light sources 2 and 3 already provided therein.

Moreover, interfacing the lighting device of the present invention to a modem, a remote controlling thereof is achieved and by means of a remote access to the operative program for managing the lighting device/s. Accordingly, this optimizes both the servicing and the maintenance costs, thereby greatly limiting the maintenance expenses.

1. A device for the signalling and lighting during an emergency condition, comprising a casing (1) wherein a visible light source (2) is housed,
characterized in that it further comprises a second visible UV light source (3).

2. The device for the signalling and lighting during an emergency condition according to claim 1, wherein said second visible UV light source (3) is a Wood lamp light.

3. The device for the signalling and lighting during an emergency condition according to claim 1 or 2, wherein said casing further comprises a signalling or informative board (4) apt to be lighted by said first and/or second source (2,3).

4. The device for the signalling and lighting during an emergency condition according to any one of the preceding claims, wherein said casing further comprises a device (4) for detecting an environmental condition.

5. The device for the signalling and lighting during an emergency condition according to the preceding claim, wherein said device (4) for detecting an environmental condition is selected from the group comprising a sensor for detecting smoke, heat, gas, Carbon oxide, CFCs.

6. The device for the signalling and lighting during an emergency condition according to any one of the preceding claims, wherein said casing (1) further comprises a webcam or a micro camera.

7. The device for the signalling and lighting during an emergency condition according to any one of the preceding claims, wherein said casing (1) further comprises a laser light source.

8. The device for the signalling and lighting during an emergency condition according to any one of the preceding claims, wherein said casing (1) further comprises a modem device.

9. The device for the signalling and lighting during an emergency condition according to any one of the preceding claims, characterized in that it is apt to be connected to a network of alike devices (1) for the signalling and lighting during an emergency condition and to be remotely managed via a control unit.

10. The device for the signalling and lighting during an emergency condition according to any one of the preceding claims, further comprising the use of signalling elements such as boards, signs or the like having a photo-reactive varnish finishing applied thereon for cooperating with said light sources (2,3).
